(19) United States
(12) Patent Application Publication
(10) Pub. No.: US 2025/0337627 A1
(43) Pub. Date: Oct. 30, 2025

(54) REDUCING PEAK TO AVERAGE POWER RATIO IN CELLULAR COMMUNICATION SYSTEMS

(71) Applicant: Nokia Technologies Oy, Espoo (FI)

(72) Inventors: Jukka Olavi TALVITIE, Tampere (FI); Ismael PERUGA NASARRE, Oulu (FI); Oskari TERVO, Oulu (FI); Esa Tapani TIIROLA, Oulu (FI); Mikko VALKAMA, Nokia (FI)

(21) Appl. No.: 18/866,856

(22) PCT Filed: May 20, 2022
(86) PCT No.: PCT/EP2022/063682

§ 371 Date: Nov. 18, 2024

(51) Int. Cl. H04L 27/26; H04L 5/00

(52) U.S. Cl. CPC H04L 27/2614; H04L 5/0051; H04L 27/26526

(57) ABSTRACT

According to an example aspect of the present invention, there is provided an apparatus comprising, means for determining a first precoder for an uplink transmission, wherein the uplink transmission comprises user data and/or an uplink reference signal, and at least one second precoder for a peak cancellation signal, means for deciding whether to transmit, along with the uplink transmission, the peak cancellation signal using one of the at least one second precoder and means for transmitting, depending on said decision, at least the uplink transmission to a wireless network node using the first precoder.

### FIELD

Various example embodiments relate in general to cellular communication systems and more specifically, to reducing Peak-to-Average Power Ratio, PAPR, in such systems.

### BACKGROUND

Peak-to-Average Power Ratio, PAPR, may occur for example in multicarrier communication systems, wherein different sub-carriers may be out of phase compared to each other, thereby causing a peak in an output envelope. Reduction of PAPR is thus important at least in various cellular networks, such as, in networks operating according to Long Term Evolution, LTE, and/or fifth generation, 5G, radio access technology. 5G radio access technology may also be referred to as New Radio, NR, access technology. 3rd Generation Partnership Project, 3GPP, still develops LTE and also standards for 5G/NR. Reduction of PAPR may also be beneficial in other wireless communication networks in the future as well, such as in 6G networks.

### SUMMARY

According to some aspects, there is provided the subject-matter of the independent claims. Some embodiments are defined in the dependent claims.

The scope of protection sought for various embodiments of the invention is set out by the independent claims. The embodiments and features, if any, described in this specification that do not fall under the scope of the independent claims are to be interpreted as examples useful for understanding various embodiments of the invention.

According to a first aspect of the present invention, there is provided an apparatus comprising means for determining a first precoder for an uplink transmission, wherein the uplink transmission comprises user data and/or an uplink reference signal, and at least one second precoder for a peak cancellation signal, means for deciding whether to transmit, along with the uplink transmission, the peak cancellation signal using one of the at least one second precoder and means for transmitting, depending on said decision, at least the uplink transmission to a wireless network node using the first precoder. The apparatus of the first aspect may be a User Equipment, UE, or a device configured to control the functioning thereof.

Embodiments of the first aspect may comprise at least one feature from the following bulleted list, or any combination thereof:
the apparatus further comprises means for transmitting, if it is decided that the peak cancellation signal is to be transmitted with said one of the at least one second precoder, the uplink transmission to the wireless network node using the first precoder and the peak cancellation signal using said one of the at least one second precoder;
wherein the peak cancellation signal is transmitted via a subset of frequency and/or time resources reserved for said user data and/or the uplink reference signal;
wherein the at least one second precoder comprises at least two second precoders and the apparatus further comprises means for selecting said one of the at least one second precoder for the peak cancellation signal from the at least two second precoders;
the apparatus further comprises means for transmitting, if it is decided that the peak cancellation signal is not to be transmitted using any of the at least one second precoder, the uplink transmission to the wireless network node without transmitting the peak cancellation signal;
wherein said decision is performed separately for each symbol, wherein the symbol is a Cyclic Prefix—Orthogonal Frequency Division Multiplexing, OFDM, CP-OFDM, symbol, a Discrete Fourier Transform—spread—OFDM, DFT-s-OFDM, symbol or a Known Tail—DFT-s-OFDM, KT-DFT-s-OFDM, symbol;
the apparatus further comprises means for receiving, from the wireless network node, information about a first transmission rank and a second transmission rank, wherein the first transmission rank is for transmitting the uplink transmission without the peak cancellation signal and the second transmission rank is for transmitting the uplink transmission with the peak cancellation signal and means for transmitting, depending on said decision, the uplink transmission to the wireless network node using the first transmission rank or the second transmission rank;
the apparatus further comprises means for receiving from the wireless network node indicators of the first precoder and the at least one second precoder or means for receiving from the wireless network node an indicator of the first precoder and means for deriving the at least one second precoder from the indicator of the first precoder;
wherein said indicators are received in an uplink scheduling grant;
the apparatus further comprises means for receiving from the wireless network node a limit for an error vector magnitude, power level and/or power density associated with the at least one second precoder; wherein said means for deciding whether to transmit the peak cancellation signal using said one of the at least one second precoder is based on the limit for the error vector magnitude, power level and/or power density of each of the at least one second precoder;
wherein said means for deciding whether to transmit the peak cancellation signal using said one of the at least one second precoder is based on at least one of:
   an evaluation of an efficiency of said one of the at least one second precoder;
   spatial of suitability said one of the at least one second precoder; and/or
   channel measurements of the apparatus;
the apparatus further comprises means for transmitting to the wireless network node, a notification about said one of the at least one second precoder and/or means for transmitting, to the wireless network node, a notification about whether the apparatus has used the at least one second precoder;
wherein the cross-correlation between the first precoder and each of the at least one second precoder is substantially zero;
wherein a transmission rank of the first precoder is smaller than a number of antenna ports of the user equipment, wherein said antenna ports are configured for uplink transmissions;
wherein the uplink transmission is a CP-OFDM transmission, a DFT-s-OFDM, transmission or a KT-DFT-s-OFDM, transmission.

According to a second aspect of the present invention, there is provided an apparatus comprising means for determining, for a user equipment, a first precoder for an uplink transmission, wherein the uplink transmission comprises user data and/or an uplink reference signal, and at least one second precoder for a peak cancellation signal and means for receiving an uplink transmission from the user equipment in accordance with at least the first precoder. The apparatus of the second aspect may be a wireless network node or a device configured to control the functioning thereof.

Embodiments of the second aspect may comprise at least one feature from the following bulleted list, or any combination thereof:
the apparatus further comprises means for receiving the uplink transmission from the user equipment in accordance with the first precoder and the peak cancellation signal in accordance with one of the at least one second precoder;
wherein the peak cancellation signal is received via a subset of frequency and/or time resources reserved for said user data and/or the uplink reference signal;
wherein the at least one second precoder comprises at least two second precoders;
the apparatus further comprises means for receiving the uplink transmission from the user equipment in accordance with the first precoder without receiving the peak cancellation signal;
the apparatus further comprises means for transmitting, to the user equipment, information about a first transmission rank and a second transmission rank, wherein the first transmission rank is for transmitting the uplink transmission without the peak cancellation signal and the second transmission rank is for transmitting the uplink transmission with the peak cancellation signal and means for receiving, from the user equipment, the uplink transmission in accordance with the first transmission rank or the second transmission rank;
the apparatus further comprises means for transmitting to the user equipment indicators of the first precoder and the at least one second precoder or means for transmitting to the user equipment an indicator of the first precoder, wherein the at least one second precoder is to be derived from the indicator of the first precoder;
wherein said indicators are transmitted in an uplink scheduling grant;
the apparatus further comprises means for transmitting to the user equipment a limit for an error vector magnitude, power level and/or power density associated with the at least one second precoder;
the apparatus further comprises means for receiving from the user equipment a notification about said one of the at least one second precoder and/or means for receiving from the user equipment a notification about whether the user equipment has used the at least one second precoder.

According to a third aspect, there is provided a first method comprising, determining a first precoder for an uplink transmission, wherein the uplink transmission comprises user data and/or an uplink reference signal, and at least one second precoder for a peak cancellation signal, deciding whether to transmit, along with the uplink transmission, the peak cancellation signal using one of the at least one second precoder and transmitting, depending on said decision, at least the uplink transmission to a wireless network node using the first precoder. The first method may be performed by a User Equipment, UE, or a device configured to control the functioning thereof.

According to a fourth aspect, there is provided a second method comprising, determining, for a user equipment, a first precoder for an uplink transmission, wherein the uplink transmission comprises user data and/or an uplink reference signal, and at least one second precoder for a peak cancellation signal and receiving an uplink transmission from the user equipment in accordance with at least the first precoder. The second method may be performed by a wireless network node or a device configured to control the functioning thereof.

According to a fifth aspect of the present invention, there is provided an apparatus, such as a wireless transmitter, comprising at least one processing core, at least one memory including computer program code, the at least one memory and the computer program code being configured to, with the at least one processing core, cause the apparatus at least to determine a first precoder for an uplink transmission, wherein the uplink transmission comprises user data and/or an uplink reference signal, and at least one second precoder for a peak cancellation signal, decide whether to transmit, along with the uplink transmission, the peak cancellation signal using one of the at least one second precoder and transmit, depending on said decision, at least the uplink transmission to a wireless network node using the first precoder. The apparatus of the fifth aspect may be a User Equipment, UE, or a device configured to control the functioning thereof.

According to a sixth aspect of the present invention, there is provided an apparatus, such as a wireless receiver, comprising at least one processing core, at least one memory including computer program code, the at least one memory and the computer program code being configured to, with the at least one processing core, cause the apparatus at least to determine, for a user equipment, a first precoder for an uplink transmission, wherein the uplink transmission comprises user data and/or an uplink reference signal, and at least one second precoder for a peak cancellation signal and receive an uplink transmission from the user equipment in accordance with at least the first precoder. The apparatus of the sixth aspect may be a wireless network node or a device configured to control the functioning thereof.

According to a seventh aspect of the present invention, there is provided a non-transitory computer readable medium having stored thereon a set of computer readable instructions that, when executed by at least one processor, cause an apparatus to at least perform the first method. According to an eighth aspect of the present invention, there is provided a non-transitory computer readable medium having stored thereon a set of computer readable instructions that, when executed by at least one processor, cause an apparatus to at least perform the second method.

According to a ninth aspect of the present invention, there is provided a computer program comprising instructions which, when the program is executed by an apparatus, cause the apparatus to carry out the first method. According to a tenth aspect of the present invention, there is provided a computer program comprising instructions which, when the program is executed by an apparatus, cause the apparatus to carry out the second method.

### BRIEF DESCRIPTION OF THE DRAWINGS

FIG. 1 illustrates a network scenario in accordance with at least some example embodiments;

FIG. 2 illustrates a first signalling graph in accordance with at least some example embodiments;

FIG. 3 illustrates a second signalling graph in accordance with at least example some embodiments;

FIG. 4 illustrates an example apparatus capable of supporting at least some example embodiments;

FIG. 5 illustrates a flow graph of a first method in accordance with at least some example embodiments;

### EMBODIMENTS

Peak-to-Average Power Ratio, PAPR, may be reduced in cellular communication systems by the procedures described herein. Alternatively, or in addition, other metrics than PAPR may be used, such as Cubic Metric, CM. In the end, an output backoff may be the metric that matters. For instance, Output Power Backoff, OBO, may be defined in terms of maximum power reduction, i.e., what is the minimum power a User Equipment, UE, should provide in a certain scenario. PAPR and/or CM, and other similar metrics, may be used to approximate the OBO requirement for a transmitter of the UE. However, the final truth may be obtained only via simulations and/or measurements involving a UE power amplifier or a UE power amplifier model, and the related UE radio frequency requirements, such as Error Vector Magnitude, EVM, Inband Emission, IBE, Occupied Channel Bandwidth, OCB, and Adjacent Channel Leakage Ratio, ACLR.

More specifically, separate precoders may be selected for an uplink transmission, like transmission of user data and/or an uplink reference signal, and for transmission of a Peak Cancellation Signal, PCS. That is, a first precoder may be selected for the uplink transmission and a second precoder may be selected for the PCS. Tone selection and reservation for the PCS may be therefore performed in spatial domain thereby enabling transmission of the PCS by a UE without using additional spectrum. In general, the uplink transmission may cover one or more Orthogonal Frequency Division Multiplexing, OFDM, symbols. The PCS may be transmitted via a subset of frequency and/or time resources reserved for said user data and/or the uplink reference signal.

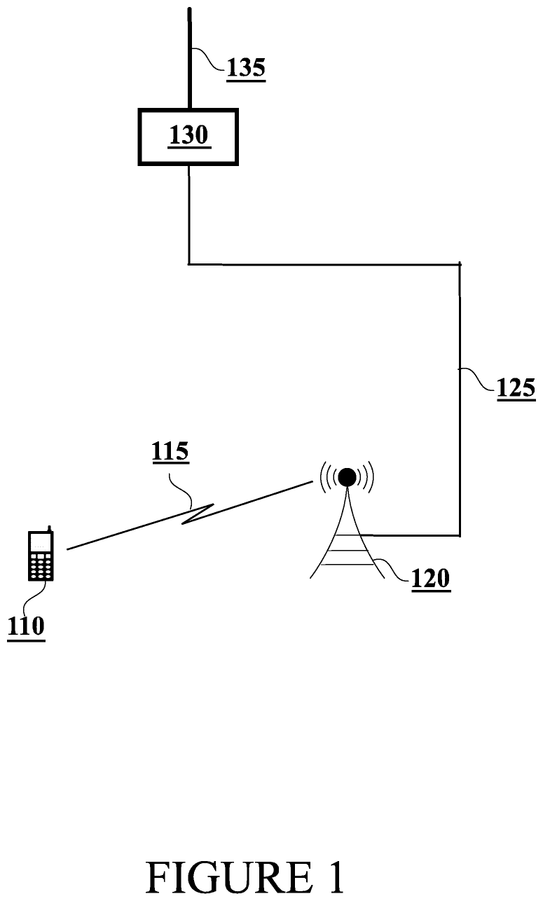

FIG. 1 illustrates a network scenario in accordance with at least some example embodiments. According to the example network scenario of FIG. 1, there may be a cellular communication system, which comprises UE 110, wireless network node 120 and core network element 130. UE 110 may be connected to wireless network node 120 via air interface 115 and wireless network node 120 may be further connected to core network element 130 via wired interface 125. In some example embodiments, air interface 115 may a beam-based interface.

UE 110 may comprise, for example, a smartphone, a cellular phone, a Machine-to-Machine, M2M, node, Machine-Type Communications, MTC, node, RedCap UE (Reduced Capability UE) node, an Internet of Things, IoT, node, a car telemetry unit, a laptop computer, a tablet computer or, indeed, any kind of suitable wireless terminal, like a relay. Wireless network node 120 may be considered as a serving node for UE 110 and one cell of wireless network node 120 may be a serving cell for UE 110.

Air interface 115 between UE 110 and wireless network node 120 may be configured in accordance with a Radio Access Technology, RAT, which both UE 110 and wireless network node 120 are configured to support. Examples of cellular RATs include Long Term Evolution, LTE, New Radio, NR, which may also be known as fifth generation, 5G, radio access technology and MulteFire. For example in the context of LTE, wireless network node 120 may be referred to as eNB while wireless network node 120 may be referred to as gNB in the context of NR. In some example embodiments, wireless network node 120 may be referred to as a Transmission and Reception Point, TRP, or control multiple TRPs that may be co-located or non-co-located. In some example embodiments, wireless network node 120 may be a relay. In any case, example embodiments of the present disclosure are not restricted to any particular wireless technology. Instead, example embodiments may be exploited in any wireless communication network wherein reduction of PAPR is desirable.

Wireless network node 120 may be connected, directly or via at least one intermediate node, with core network element 130 via interface 125. Core network element 130 may be, in turn, coupled via interface 135 with another network (not shown in FIG. 1), via which connectivity to further networks may be obtained, for example via a worldwide interconnection network. Wireless network node 120 may be connected, directly or via at least one intermediate node, with core network element 130 or with another core network.

In some example embodiments, the network scenario may comprise a relay node instead of, or in addition to, UE 110 and/or wireless network node 120. Relaying may be used for example when operating on millimeter-wave frequencies. One example of the relay node may be an Integrated Access and Backhaul, IAB, node. The IAB node may be referred to as a self-backhauling relay as well. Another example of a relay may be an out-band relay. In general, the relay node may comprise two parts:
1) Distributed Unit, DU, part which may facilitate functionalities of wireless network node 120, such as a gNB. Thus, in some example embodiments, the DU part of a relay may be referred to as wireless network node 120 and the DU may perform tasks of wireless network node 120;
2) Mobile Termination, MT, part which may facilitate functionalities of UE 110, i.e., a backhaul link which may be the communication link between a parent node (DU), such as a DU part of wireless network node 120, and the relay, such as an IAB node. In some example embodiments, the MT part may be referred to as UE 110 and perform tasks of UE 110.

Embodiments of the present disclosure consider precoding and spectrum utilization of uplink transmissions, e.g., for 5G/NR. At the side of UE 110, high PAPR of OFDM waveforms may be one of the limiting factors for efficient Power Amplifier, PA, utilization. In order to preserve quality of the waveform quality, e.g., with respect to EVM, PA backoff may be introduced. However, PA backoff would then limit the potential coverage of uplink transmissions of UE 110 due to decreased output power. Another approach to mitigate PAPR may be to apply a bigger PA, which could amplify also peaks linearly. The problem with such approach would be though that the power consumption of UE 110 and the PA cost would increase accordingly.

PAPR may be reduced for example using frequency-multiplexed tone reservation signals but such signals would require additional frequency resources and reduce the spectral efficiency. Embodiments of the present disclosure therefore provide a precoding-based PAPR reduction and for example related signalling between UE 110 and wireless network node 120, at least for codebook-based and non-codebook-based uplink transmissions. Thus, the PAPR statistics of the transmitted waveform may be improved without introducing a direct loss in spectral efficiency due to allocation of time-frequency resources of an additional PCS, like in case of tone reservation signals.

In some example embodiments, a first spatial precoder may be selected for an uplink transmission, such as for transmission of the user data of UE 110, and a second spatial precoder may be selected for the PCS. For instance, for UEs performing codebook-based transmissions in PAPR limited scenarios, e.g., at the cell edge, wireless network node 120 may schedule UE 110 with at least one second precoder for transmission of the PCS in addition to scheduling UE 110 with the first precoder for the uplink transmission. The at least one second precoder may be selected in such a manner, e.g., by spanning the null space of the channel, that the at least one second precoder does not significantly interfere with the uplink transmission. Wireless network node 120 may for example take into account the interference of the emitted PCS energy at different devices when selecting the at least one second precoder for the PCS.

Wireless network node 120 may transmit indicators of the selected first and at least one second precoder to UE 110. Said indicators of the selected first and at least one second precoder may be transmitted in an uplink scheduling grant for example. The at least one second precoder for the PCS may be selected from the same codebook as the first precoder for said user data, or from a separate codebook.

Alternatively or in addition, wireless network node 120 may transmit information about a first transmission rank and a second transmission rank to UE 110, possibly in the uplink scheduling grant as well, wherein the first transmission rank is for transmitting the uplink transmission without the PCS and the second transmission rank is for transmitting the uplink transmission along with the PCS. Wireless network node 120 may define the first and the second transmission rank, i.e., the number of layers, separately for transmission of the uplink transmission without the PCS, and for transmission of the uplink transmission without the PCS.

In some example embodiments, UE 110 may thus determine the first precoder for the uplink transmission and the at least one second precoder for the PCS from the indicators received from wireless network node 120. Alternatively, UE 110 may receive from wireless network node 120 an indicator of the first precoder and derive the at least one second precoder from the indicator of the first precoder. UE 110 may then decide whether to transmit the PCS, along with the uplink transmission, with one of at least one second precoder. UE 110 may perform said decision separately for each symbol, wherein the symbol may be a Cyclic Prefix—Orthogonal Frequency Division Multiplexing, OFDM, CP-OFDM, symbol, a Discrete Fourier Transform—spread—OFDM, DFT-s-OFDM, symbol or a Known Tail—DFT-s-OFDM, KT-DFT-s-OFDM, symbol. UE 110 may make the decision about whether to use the at least one second precoder and transmit the PCS based on allocation of the at least one second precoder and related network configuration.

For UEs performing non-codebook-based transmissions, for example in PAPR limited scenarios, UE 110 may also utilize the at least one second precoder for the PCS transmission. BS 120 may configure UE 110, for example using Radio Resource Control, RRC, signalling, with a number of Sounding Reference Signal, SRS ports. UE 110 may then utilize the at least one second precoder for the PCS transmission for each SRS port based on downlink signals, such as Channel State Information—Reference Signals, CSI-RSs.

For instance, UE 110 may utilize the at least one second precoder for the PCS transmission together with the first precoder when setting up an uplink data transmission, i.e., when transmitting an uplink reference signal, like a layer-wise SRS for the upcoming uplink data transmission of user data.

In some example embodiments, UE 110 may determine the at least one second precoder for the PCS transmission based on SRS port(s) indicated for uplink data, such as Physical Uplink Shared Channel, PUSCH, data, with or without separate feedback from BS 120.

In some example embodiments, UE 110 may propose, or notify, wireless network node 120 about the use of the at least one second precoder for the PCS transmission when setting up the uplink data transmission, i.e., when transmitting the uplink reference signal. UE 110 may for example transmit a notification about the at least one second precoder to wireless network node. That is, UE 110 may propose, or notify, wireless network node 120 about one second precoder that it is using or multiple candidate precoders.

For both cases, codebook-based and non-codebook-based transmissions, there may be an upper limit for the maximum power available for transmission of the PCS, i.e., for the use of the at least one second precoder for the PCS. The maximum power available for transmission of the PCS may be predefined in the specifications, such as in 3GPP standards, or the maximum power available for transmission of the PCS may be controlled by a parameter configured by wireless network node 120, using for example RRC signalling.

Embodiments of the present disclosure may be applied for both multicarrier transmissions, such as OFDM, and single carrier transmissions, such as DFT-s-OFDM. For instance, embodiments of the present disclosure may be applied at least for OFDM transmissions, such as CP-OFDM, and single carrier transmissions defined according to frequency domain signal generation, such as DFT-s-OFDM and KT-DFT-s-OFDM.

In some example embodiments of the present disclosure, all frequency resources may be available for the uplink transmission, such as transmission of user data or an uplink reference signal, because the PCS may be multiplexed with the uplink transmission in spatial domain. The transmitted signal x, comprising the uplink transmission and the PCS, at an arbitrary chosen subcarrier may be written as

$$x = α Vs + β Wr , \qquad ( 1 )$$

wherein V is N_{TX}*N_{S} size precoder matrix for the uplink transmission, wherein N_{TX} is a number of transmit antenna ports and N_{S} is a number of layers (rank), s is N_{S}*1 vector of data symbols, W is the precoder matrix for the PCS, and r is the vector of PCS values. Furthermore, α and β are power scaling factors for the uplink transmission and PCS, respectively. The size of the vector term Wr may be fixed to N_{TX}*1, but the individual sizes of matrix W and vector r may vary depending on the selected transmission rank and PCS configuration. In order to enable a spatially multiplexed PCS, the transmission rank of the uplink transmission, i.e., the first transmission may need to be smaller than the number of transmit antenna ports of UE 110, i.e., N_{S}<N_{TX}, wherein said antenna ports are configured for uplink transmissions.

To minimize the interference caused by the PCS on the uplink transmission, such as user data or the uplink reference signal, the at least one second precoder for the PCS may be designed to span the null space of the channel between UE 110 and wireless network node 120. However, with a codebook-based approach, precoding may be applied only with limited resolution with respect to the channel due to a finite set of available precoder options.

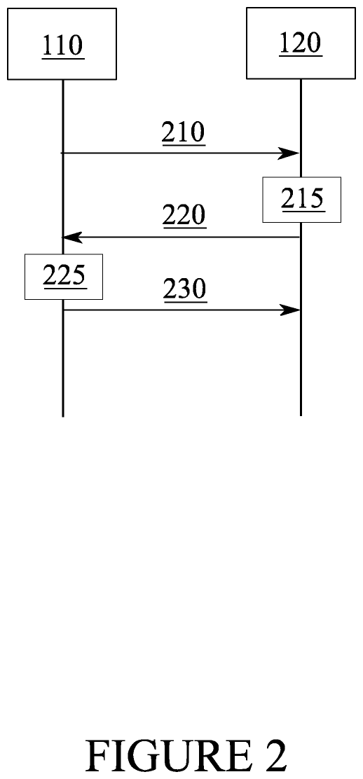

FIG. 2 illustrates a first signalling graph in accordance with at least some example embodiments. More specifically, FIG. 2 illustrates signalling in case of a codebook-based transmission using precoding-based PAPR reduction, for example after UE 110 has signalled its capability for PCS generation in the spatial domain. In case of the codebook-based transmission, the uplink transmission may comprise user data.

At step 210, UE 110 may perform channel sounding, for example by transmitting uplink reference signals, such as SRSs, to wireless network node 120. Alternatively, or in addition, UE 110 may perform Demodulation Reference Signal, DMRS, transmissions. At step 215, wireless network node 120 may decide a first precoder for the uplink transmission, at least one second precoder for the PCS, and possibly a first transmission rank and a second transmission rank, wherein the first transmission rank is for transmitting the uplink transmission without the PCS and the second transmission rank is for transmitting the uplink transmission with the PCS. In some example embodiments, wireless network node 120 may set limits for EVM, power level and/or power density of the PCS transmission.

At step 220, wireless network node 120 may transmit indicators of the first precoder and the at least one second precoder, and possibly information about the first transmission rank and the second transmission rank, to UE 110, possibly in an uplink scheduling grant. The indicators may comprise for example a Transmitted Precoding Matrix Indicator, TPMI, of the first precoder and a TPMI for each second precoder. In some example embodiments, wireless network node 120 may transmit the limits for EVM, power level and/or power density of the PCS transmission to UE 110. The limits may be transmitted in an uplink scheduling grant as well.

That is, the transmission rank(s) and the uplink precoder(s) may be defined by the network, such as wireless network node 120, from a codebook and be further signalled to UE 110 as part of the uplink scheduling grant, or in another message, e.g., a control message. The precoder(s) identification may be based on the TPMI(s). So if there is a need for PAPR reduction in the uplink transmission, e.g., due to coverage enhancement, the network, i.e., wireless network node 120, is able to inform UE 110 about the uplink transmission rank(s) and precoder(s), as well as related configuration parameters, such as the limits for EVM, power level and/or power density of the PCS transmission. For example, the total power available for the at least one second precoder and/or power spectral density for the at least one second precoder may be upper limited to a predefined value, such as a value specified in a 3GPP standard, or to a configured value, configured by wireless network node 120.

The at least one second precoder, selected by the network, may match with the number of transmission ports of UE 110. The at least one second precoder for the PCS may, but is not forced to, be selected from the precoder set of the same rank used with the uplink transmission, such as user data. For example, when considering rank 2 transmission with 4 antenna ports, the first precoder may be selected to be one of the 4×2 precoder matrices available in the codebook, but the at least one second precoder may be selected as one of the remaining precoders of the same set used for the uplink transmission, or alternatively as one or multiple precoders from an arbitrary rank codebook with 4 antenna ports.

At step 225, UE 110 may determine, based on the received indicators, the first precoder for the uplink transmission and the at least one second precoder for the PCS. UE 110 may further decide whether to transmit, along with the uplink transmission, the PCS using one of at least one second precoder. That is, UE 110 may decide based on the received scheduling grant, to use, or not to use, the PAPR reduction with the provided at least one second precoder.

In some example embodiments, the decision may be based on the evaluation of an efficiency of said one of the at least one second precoder, spatial suitability of said one of the at least one second precoder for the current transmission and/or the associated power restrictions. When the at least one second precoder does not sufficiently span the same spatial space compared to an optimal PCS, it may be more power-efficient to ignore the PCS and related at least one second precoder. That is, UE 110 may decide that the PCS is not to be transmitted with any of the at least one second precoder due to power-inefficiency. Similarly, UE 110 may select, if the at least one second precoder comprises at least two second precoders, one of the at least one second precoder for the peak cancellation signal from the at least two second precoders based on the evaluation of an efficiency of said one of the at least one second precoder, spatial suitability of said one of the at least one second precoder for the current transmission and/or the associated power restrictions.

Depending on the network configuration, UE 110 may signal whether it has used one of the at least one second precoder or not by transmitting a notification about the use. The notification about whether UE 110 has used said one of the at least one second precoder or not may be included in each uplink transmission with PCS opportunity. Another option may be to include the notification about whether UE 110 has used said one of the at least one second precoder in another signal, such as power headroom report.

At step 230, UE 110 may transmit, depending on said decision at step 225, at least the uplink transmission to wireless network node 120 using the first precoder. If UE 110 decided that the PCS is to be transmitted with said one of the at least one second precoder, UE 110 may transmit the uplink transmission to wireless network node 120 using the first precoder and the PCS using said one of the at least one second precoder, possibly using the second transmission rank. On the other hand, if UE 110 decided that the PCS is not to be transmitted using any of the at least one second precoder, UE 110 may transmit the uplink transmission to wireless network node 120 without transmitting the PCS, possibly using the first transmission rank. So depending on said decision at step 225, UE 110 may transmit the uplink transmission to wireless network node 120 using the first transmission rank or the second transmission rank.

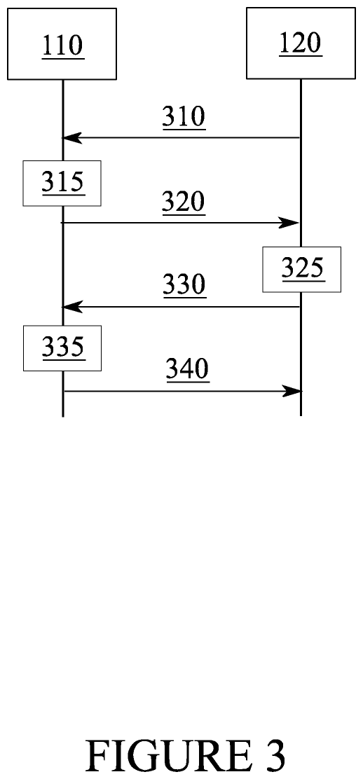

FIG. 3 illustrates a second signalling graph in accordance with at least some example embodiments. More specifically, FIG. 3 illustrates signalling in case of a non-codebook-based transmission using precoding-based PAPR reduction. In case of the non-codebook-based transmission, the uplink transmission may comprise an uplink reference signal, like an SRS, or user data.

At step 310, wireless network node 120 may transmit downlink reference signals, such as CSI-RSs. UE 110 may obtain uplink channel information based on the received downlink reference signals by assuming channel reciprocity. At step 315, UE 110 may then determine a first precoder for the uplink transmission, wherein said uplink transmission comprises an uplink reference signal, like SRS. UE 110 may also determine at least one second precoder for a PCS and decide whether to transmit, along with the uplink transmission, the PCS using one of at least one second precoder.

That is, in some example embodiments, UE 110 may decide whether to transmit, along with the uplink transmission, the peak cancellation signal using one of the at least one second precoder based on channel measurements of UE 110. Similarly, UE 110 may select, if the at least one second precoder comprises at least two second precoders, one of the at least one second precoder for the peak cancellation signal from the at least two second precoders based on the channel measurements of UE 110.

At step 320, UE 110 may transmit, depending on said decision, at least the uplink transmission to wireless network node 120 using the first precoder. The uplink transmission may be a layer-wise SRS transmission with the at least one second precoder selected by UE 110. If UE 110 decided that the PCS is to be transmitted using said one of the at least one second precoder, UE 110 may transmit the uplink transmission to wireless network node 120 using the first precoder and the PCS using the at least one second precoder, possibly using the second transmission rank. On the other hand, if UE 110 decided that the PCS is not to be transmitted using any of the at least one second precoder, UE 110 may transmit the uplink transmission to wireless network node 120 without transmitting the PCS, possibly using the first transmission rank. So depending on said decision, UE 110 may transmit the uplink transmission to wireless network node 120 using the first transmission rank or the second transmission rank. UE 110 may perform the transmission on each selected beam. UE 110 may transmit to wireless network node a notification about said one of the at least one second precoder and/or a notification about whether it has used the at least one second precoder.

At step 325, wireless network node 120 may determine which of the at least one second precoder selected by UE 110 may be used for a subsequent uplink transmission, wherein the subsequent uplink transmission comprises user data. Wireless network node 120 may decide a first precoder for the uplink transmission, at least one second precoder for the PCS, and possibly a first transmission rank and a second transmission rank, wherein the first transmission rank is for transmitting the uplink transmission without the PCS and the second transmission rank is for transmitting the uplink transmission with the PCS. In some example embodiments, wireless network node 120 may set limits for EVM, power level and/or power density of the PCS transmission.

At step 330, wireless network node 120 may transmit indicators of the first precoder and the at least one second precoder for the subsequent uplink transmission, and possibly information about the first transmission rank and the second transmission rank, to UE 110, possibly in an uplink scheduling grant.

At steps 335 and 340, UE 110 may perform the same steps as at steps 225 and 230 of FIG. 2, respectively.

In order to enable efficient peak cancellation performance, the first precoder for the uplink transmission, such as user data, and the at least one second precoder for the PCS, may be selected in such way that their cross-correlation is zero, i.e., V^{H}W=0. It is noted that the cross-correlation may be substantially zero, as exactly zero may be difficult, or even impossible, to achieve in practice. This operation is not dependent on the channel, and thus does not assume any channel knowledge.

In order to maximize Signal-to-Interference Ratio, SIR, between the uplink transmission, such as user data, and the PCS at the receiver, the SIR may be evaluated for each combination of the first precoder and each of the at least one second precoder that fulfill the above-stated zero-correlation condition. After this, the precoder combination, which maximizes the SIR may be selected for the transmission. The SIR evaluation may be based on the full combined channel effect including the radio channel and precoders, and thus require utilization of channel estimates.

Example embodiments of the present disclosure therefore provide considerable potential for improving power efficiency. Also, unused channel rank may leveraged, instead of additional resource elements, for improved spectral efficiency. Both, codebook-based and non-codebook-based transmission scenario, may be supported. Example embodiments of the present disclosure may be applied at least in Frequency Range 1, FR1, and FR2 scenarios, and higher frequency bands, like beyond 71 GHz and sub-THz.

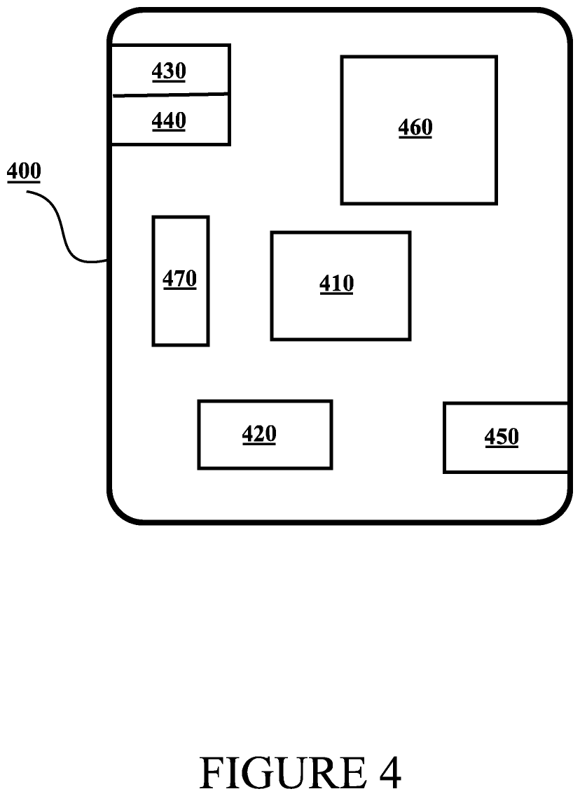

FIG. 4 illustrates an example apparatus capable of supporting at least some embodiments. Illustrated is device 400, which may be referred to as, for example, UE 110 or wireless network node 120, or a device configured to control the functioning thereof. Comprised in device 400 is processor 410, which may comprise, for example, a single-or multi-core processor wherein a single-core processor comprises one processing core and a multi-core processor comprises more than one processing core. Processor 410 may comprise, in general, a control device. Processor 410 may comprise more than one processor. Processor 410 may be a control device. A processing core may comprise, for example, a Cortex-A8 processing core manufactured by ARM Holdings or a Steamroller processing core produced by Advanced Micro Devices Corporation. Processor 410 may comprise at least one Qualcomm Snapdragon and/or Intel Atom processor. Processor 410 may comprise at least one Application-Specific Integrated Circuit, ASIC. Processor 410 may comprise at least one Field-Programmable Gate Array, FPGA. Processor 410 may be means for performing method steps in device 400. Processor 410 may be configured, at least in part by computer instructions, to perform actions.

A processor may comprise circuitry, or be constituted as circuitry or circuitries, the circuitry or circuitries being configured to perform phases of methods in accordance with embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory(ies) that work together to cause an apparatus, such as UE 110 or wireless network node 120, or a device configured to control the functioning thereof, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 400 may comprise memory 420. Memory 420 may comprise random-access memory and/or permanent memory. Memory 420 may comprise at least one RAM chip. Memory 420 may comprise solid-state, magnetic, optical and/or holographic memory, for example. Memory 420 may be at least in part accessible to processor 410. Memory 420 may be at least in part comprised in processor 410. Memory 420 may be means for storing information. Memory 420 may comprise computer instructions that processor 410 is configured to execute. When computer instructions configured to cause processor 410 to perform certain actions are stored in memory 420, and device 400 overall is configured to run under the direction of processor 410 using computer instructions from memory 420, processor 410 and/or its at least one processing core may be considered to be configured to perform said certain actions. Memory 420 may be at least in part comprised in processor 410. Memory 420 may be at least in part external to device 400 but accessible to device 400.

Device 400 may comprise a transmitter 430. Device 400 may comprise a receiver 440. Transmitter 430 and receiver 440 may be configured to transmit and receive, respectively, information in accordance with at least one cellular or non-cellular standard. Transmitter 430 may comprise more than one transmitter. Receiver 440 may comprise more than one receiver. Transmitter 430 and/or receiver 440 may be configured to operate in accordance with Global System for Mobile Communication, GSM, Wideband Code Division Multiple Access, WCDMA, 5G/NR, 5G-Advanced, i.e., NR Rel-18 and beyond, Long Term Evolution, LTE, IS-95, Wireless Local Area Network, WLAN, Ethernet and/or Worldwide Interoperability for Microwave Access, WiMAX, standards, for example.

Device 400 may comprise a Near-Field Communication, NFC, transceiver 450. NFC transceiver 450 may support at least one NFC technology, such as NFC, Bluetooth, Wibree or similar technologies.

Device 400 may comprise User Interface, UI, 460. UI 460 may comprise at least one of a display, a keyboard, a touchscreen, a vibrator arranged to signal to a user by causing device 400 to vibrate, a speaker and a microphone. A user may be able to operate device 400 via UI 460, for example to accept incoming telephone calls, to originate telephone calls or video calls, to browse the Internet, to manage digital files stored in memory 420 or on a cloud accessible via transmitter 430 and receiver 440, or via NFC transceiver 450, and/or to play games.

Device 400 may comprise or be arranged to accept a user identity module 470. User identity module 470 may comprise, for example, a Subscriber Identity Module, SIM, card installable in device 400. A user identity module 470 may comprise information identifying a subscription of a user of device 400. A user identity module 470 may comprise cryptographic information usable to verify the identity of a user of device 400 and/or to facilitate encryption of communicated information and billing of the user of device 400 for communication effected via device 400.

Processor 410 may be furnished with a transmitter arranged to output information from processor 410, via electrical leads internal to device 400, to other devices comprised in device 400. Such a transmitter may comprise a serial bus transmitter arranged to, for example, output information via at least one electrical lead to memory 420 for storage therein. Alternatively to a serial bus, the transmitter may comprise a parallel bus transmitter. Likewise processor 410 may comprise a receiver arranged to receive information in processor 410, via electrical leads internal to device 400, from other devices comprised in device 400. Such a receiver may comprise a serial bus receiver arranged to, for example, receive information via at least one electrical lead from receiver 440 for processing in processor 410. Alternatively to a serial bus, the receiver may comprise a parallel bus receiver.

Device 400 may comprise further devices not illustrated in FIG. 4. For example, where device 400 comprises a smartphone, it may comprise at least one digital camera. Some devices 400 may comprise a back-facing camera and a front-facing camera, wherein the back-facing camera may be intended for digital photography and the front-facing camera for video telephony. Device 400 may comprise a fingerprint sensor arranged to authenticate, at least in part, a user of device 400. In some embodiments, device 400 lacks at least one device described above. For example, some devices 400 may lack a NFC transceiver 450 and/or user identity module 470.

Processor 410, memory 420, transmitter 430, receiver 440, NFC transceiver 450, UI 460 and/or user identity module 470 may be interconnected by electrical leads internal to device 400 in a multitude of different ways. For example, each of the aforementioned devices may be separately connected to a master bus internal to device 400, to allow for the devices to exchange information. However, as the skilled person will appreciate, this is only one example and depending on the embodiment various ways of interconnecting at least two of the aforementioned devices may be selected without departing from the scope of the present invention.

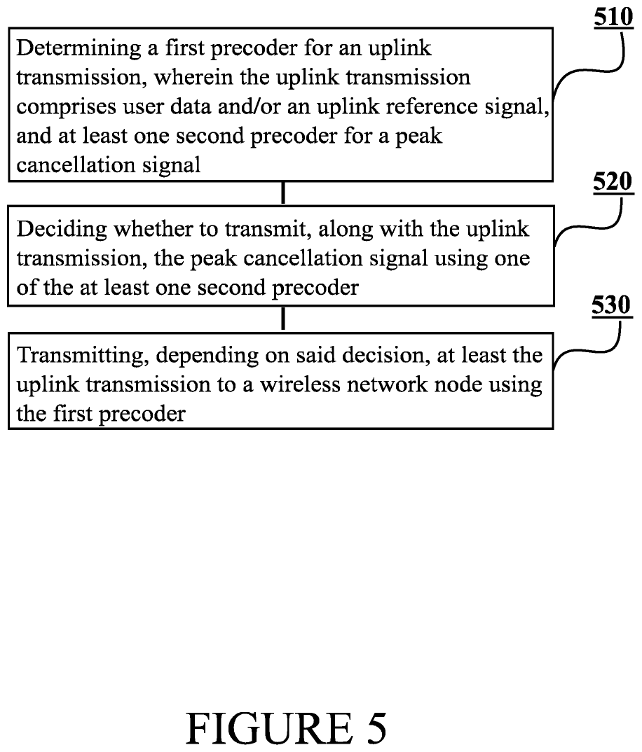

FIG. 5 is a flow graph of a first method in accordance with at least some embodiments. The phases of the illustrated first method may be performed by a UE 110, or by a control device configured to control the functioning thereof, possibly when installed therein.

The first method may comprise, at step 510, determining a first precoder for an uplink transmission, wherein the uplink transmission comprises user data and/or an uplink reference signal, and at least one second precoder for a peak cancellation signal. The first method may also comprise, at step 520, deciding whether to transmit, along with the uplink transmission, the peak cancellation signal using one of the at least one second precoder. Finally, the first method may comprise, at step 530, transmitting, depending on said decision, at least the uplink transmission to a wireless network node using the first precoder.

It is to be understood that the embodiments disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and examples may be referred to herein along with alternatives for the various components thereof. It is understood that such embodiments, examples, and alternatives are not to be construed as de facto equivalents of one another, but are to be considered as separate and autonomous representations.

In some example embodiments, an apparatus, such as, for example, UE 110 or wireless network node 120, or a device configured to control the functioning thereof, may comprise means for carrying out the embodiments described above and any combination thereof.

In some example embodiments, a computer program may be configured to cause a method in accordance with the embodiments described above and any combination thereof. In an exemplary embodiment, a computer program product, embodied on a non-transitory computer readable medium, may be configured to control a processor to perform a process comprising the embodiments described above and any combination thereof.

In some example embodiments, an apparatus, such as, for example, UE 110 or wireless network node 120, or a device configured to control the functioning thereof, may comprise at least one processor, and at least one memory including computer program code, wherein the at least one memory and the computer program code are configured to, with the at least one processor, cause the apparatus at least to perform the embodiments described above and any combination thereof.

Furthermore, the described features, structures, or characteristics may be combined in any suitable manner in one or more embodiments. In the preceding description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the embodiments in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments of the present invention find industrial application in cellular communication systems wherein it is desirable to reduce PAPR, such as in systems operating according to 3GPP standards.

### ACRONYMS LIST

3GPP 3rd Generation Partnership Project
ACLR Adjacent Channel Leakage Ratio
ASIC Application-Specific Integrated Circuit
BS Wireless network node
CP-OFDM Cyclic Prefix—OFDM
CSI-RS Channel State Information—Reference Signal
D2D Device-to-Device
DFT-s-OFDM Discrete Fourier Transform—spread—OFDM
DMRS Demodulation Reference Signal
DU Distributed Unit
EVM Error Vector Magnitude
FPGA Field-Programmable Gate Array
FR Frequency Range
GSM Global System for Mobile communication
IAB Integrated Access and Backhaul
IBE Inband Emissions
IoT Internet of Things
LTE Long-Term Evolution
KT-DFT-s-OFDM Known Tail-DFT-s-OFDM
M2M Machine-to-Machine
MT Mobile Termination
MTC Machine-Type Communications
NFC Near-Field Communication
NR New Radio
OBO Output Power Backoff
OCB Occupied Bandwidth
OFDM Orthogonal Frequency Division Multiplexing
PA Power Amplifier
PAPR Peak-to-Average Power Ratio
PCS Peak Cancellation Signal
PUSCH Physical Uplink Shared Channel
RAN Radio Access Network
RAT Radio Access Technology
RRC Radio Resource Control
SIM Subscriber Identity Module
SIR Signal-to-Interference Ratio
SRS Sounding Reference Signal
TPMI Transmitted Precoding Matrix Indicator
TRP Transmission and Reception Point
UE User Equipment
UI User Interface
WCDMA Wideband Code Division Multiple Access
WiMAX Worldwide Interoperability for Microwave Access
WLAN Wireless Local Area Network

REFERENCE SIGNS LIST

| | |
|---|---|
| 110 | User Equipment |
| 115, 125, 135 | Interfaces |
| 120 | Wireless network node |
| 130 | Core network element |
| 210-230 | Steps in FIG. 2 |
| 310-340 | Steps in FIG. 3 |
| 400-470 | Structure of the apparatus of FIG. 4 |
| 510-530 | Phases of the first method in FIG. 5 |

1-33. (canceled)

34. An apparatus, comprising:
at least one processor; and
at least one memory including computer program code;
the at least one memory and the computer program code being configured to, with the at least one processor, cause the apparatus at least to:
determine a first precoder for an uplink transmission, wherein the uplink transmission comprises user data and/or an uplink reference signal, and at least one second precoder for a peak cancellation signal;
decide whether to transmit, along with the uplink transmission, the peak cancellation signal using one of the at least one second precoder; and
transmit, depending on said decision, at least the uplink transmission to a wireless network node using the first precoder.

35. The apparatus of claim 34, wherein the apparatus is further caused to:
transmit, if it is decided that the peak cancellation signal is to be transmitted with said one of the at least one second precoder, the uplink transmission to the wireless network node using the first precoder and the peak cancellation signal using said one of the at least one second precoder.

36. The apparatus of claim 35, wherein the peak cancellation signal is transmitted via a subset of frequency and/or time resources reserved for said user data and/or the uplink reference signal.

37. The apparatus of claim 34, wherein the at least one second precoder comprises at least two second precoders and the apparatus is further caused to:
select said one of the at least one second precoder for the peak cancellation signal from the at least two second precoders.

38. The apparatus of claim 34, wherein the apparatus is further caused to:
transmit, if it is decided that the peak cancellation signal is not to be transmitted using any of the at least one second precoder, the uplink transmission to the wireless network node without transmitting the peak cancellation signal.

39. The apparatus of claim 34, wherein said decision is performed separately for each symbol, wherein the symbol is a Cyclic Prefix—Orthogonal Frequency Division Multiplexing, OFDM, CP-OFDM, symbol, a Discrete Fourier Transform—spread—OFDM, DFT-s-OFDM, symbol or a Known Tail—DFT-s-OFDM, KT-DFT-s-OFDM, symbol.

40. The apparatus of claim 34, wherein the apparatus is further caused to:
receive, from the wireless network node, information about a first transmission rank and a second transmission rank, wherein the first transmission rank is for transmitting the uplink transmission without the peak cancellation signal and the second transmission rank is for transmitting the uplink transmission with the peak cancellation signal; and
transmit, depending on said decision, the uplink transmission to the wireless network node using the first transmission rank or the second transmission rank.

41. The apparatus of claim 34, wherein the apparatus is further caused to:
receive from the wireless network node indicators of the first precoder and the at least one second precoder; or
receive from the wireless network node an indicator of the first precoder and derive the at least one second precoder from the indicator of the first precoder.

42. The apparatus of claim 34, wherein said indicators are received in an uplink scheduling grant.

43. The apparatus of claim 34, wherein the apparatus is further caused to:
receive from the wireless network node a limit for an error vector magnitude, power level and/or power density associated with the at least one second precoder; wherein
decide whether to transmit the peak cancellation signal using said one of the at least one second precoder is based on the limit for the error vector magnitude, power level and/or power density of each of the at least one second precoder.

44. The apparatus of claim 34, wherein deciding whether to transmit the peak cancellation signal using said one of the at least one second precoder is based on at least one of:
an evaluation of an efficiency of said one of the at least one second precoder;
spatial of suitability said one of the at least one second precoder; or
channel measurements of the apparatus.

45. The apparatus of claim 34, wherein the apparatus is further caused to:
transmit, to the wireless network node, a notification about said one of the at least one second precoder; and/or
transmit, to the wireless network node, a notification about whether the apparatus has used the at least one second precoder.

46. The apparatus of claim 34, wherein cross-correlation between the first precoder and each of the at least one second precoder is substantially zero.

47. The apparatus of claim 34, wherein a transmission rank of the first precoder is smaller than a number of antenna ports of the user equipment, wherein said antenna ports are configured for uplink transmissions.

48. The apparatus of claim 34, wherein the uplink transmission is a CP-OFDM transmission, a DFT-s-OFDM transmission or a KT-DFT-s-OFDM, transmission.

49. An apparatus, comprising:
at least one processor; and
at least one memory including computer program code;
the at least one memory and the computer program code being configured to, with the at least one processor, cause the apparatus at least to:
determine, for a user equipment, a first precoder for an uplink transmission, wherein the uplink transmission comprises user data and/or an uplink reference signal, and at least one second precoder for a peak cancellation signal; and
receive an uplink transmission from the user equipment in accordance with at least the first precoder.

50. The apparatus of claim 49, wherein the apparatus is further caused to:
receive the uplink transmission from the user equipment in accordance with the first precoder and the peak cancellation signal in accordance with one of the at least one second precoder.

51. The apparatus of claim 49, wherein the apparatus is further caused to:
transmit to the user equipment indicators of the first precoder and the at least one second precoder; or
transmit to the user equipment an indicator of the first precoder, wherein the at least one second precoder is to be derived from the indicator of the first precoder.

52. The apparatus of claim 49, wherein the apparatus is further caused to:
receive from the user equipment a notification about said one of the at least one second precoder; and/or
receive from the user equipment a notification about whether the user equipment has used the at least one second precoder.

53. A method, comprising:
determining a first precoder for an uplink transmission, wherein the uplink transmission comprises user data and/or an uplink reference signal, and at least one second precoder for a peak cancellation signal;
deciding whether to transmit, along with the uplink transmission, the peak cancellation signal using one of the at least one second precoder; and
transmitting, depending on said decision, at least the uplink transmission to a wireless network node using the first precoder.
